(19) United States
(12) Patent Application Publication
(10) Pub. No.: US 2005/0008443 A1
(43) Pub. Date: Jan. 13, 2005

(54) Method and device for positioning freight containers on a loading surface

(76) Inventors: Berthold Eitzenberger, Ludwigshafen (DE); Roland Hummel, Dudenhofen (DE); Axel Oetken, Ganderkesee (DE); Ludger Ostermayer, Lingenfeld (DE); Jurgen Hartmann, Mutterstadt (DE)

Correspondence Address: BIRCH STEWART KOLASCH & BIRCH, PO BOX 747, FALLS CHURCH, VA, 22040-0747, US

(21) Appl. No.: 10/480,169

(22) PCT Filed: Jun. 11, 2002
(86) PCT No.: PCT/EP02/06396

(30) Foreign Application Priority Data
Jun. 12, 2001 (DE) 101 28 390.3

(51) Int. Cl. B60P 1/64

(52) U.S. Cl. 410/94

(57) ABSTRACT

The invention relates to a method of positioning items of freight or freight containers (3) on a floor surface (51) of a hold having conveyor tracks (41, 41a) integrated into the floor surface (51) and drive units (47, 48) let into the floor surface (51). Items of freight or freight containers (3) pass over first guide elements (1) assigned to the conveyor tracks (41, 41a) and accommodating sliding bodies (70) in a first direction (43) or a second direction (42) and are aligned, on second guide elements (30) containing sliding bodies (70), in the first or second direction between the first guide element (1) and the second guide element (30). The aligned items of freight or freight containers (3) are then guided into one or more storage spaces (64, 63; 66, 65) of an additional storage area region (53) in the second direction (42) or opposite thereto. The conveyor track (41a) accommodating the second guide elements (30) is accommodated so as to be aligned with respect to a demarcation (56) with locking elements (57) of the additional storage area region (53).

The invention relates to a method and a device for positioning freight containers on a surface, for example containers of standard dimensions in the freight loading deck of aircraft, ships or on the loading surface of trucks.

U.S. Pat. No. 3,620,353 relates to a chain-driven freight movement system. According to this solution, a freight movement system is proposed which comprises a conveyor mechanism integrated into the floor of the freight compartment which, constructed as a chain and drive, is driven by a suitable motor. The chain comprises a number of interconnected rollers with supporting surfaces which can be expanded by tubular elements which can be pressurized, so that a uniform build-up of pressure is established underneath the floor surface of a pallet or a freight container to be positioned in the freight compartment. By means of the frictional contact between the floor of a pallet to be positioned or of the container, the latter is moved on supporting rollers from one position in the freight compartment to the next position. Each positioning station in the freight compartment is provided with its own tubes which can be pressurized or depressurized, so that the pallet to be positioned or the container to be positioned can be moved in the freight compartment or stopped at an appropriate positioning station.

A pull system is connected to the conveyor mechanism, constructed in the manner of a chain, with which system the pallets or the containers can be positioned in selected, previously determined positions in the freight compartment and via which the tubular elements which can be pressurized can be relieved of load, so that the conveyor mechanism releases the pallets or containers to be positioned.

In the freight storage compartments of aircraft, for example, there are ball mats in the access region of the holds and, in the further region extending in the interior of the fuselage, there are roller tracks let into the floor of the freight compartment, in order to be able to move transport containers such as containers or pallets easily and quickly. In the entry region of the loading compartment, the transport units are moved in as viewed in the Y direction (transversely with respect to the fuselage) before they are moved to their envisaged transport position over the roller tracks provided in the floor of the hold. At the positions respectively allocated to the transport units, the containers or pallets are locked, possibly also lashed, in order to prevent the transport units slipping and striking the walls of the hold.

In holds of aircraft, in particular airplanes, the rear region of the fuselage (bulk) can be loaded with containers. The movement of containers or items of freight into the bulk can be done by hand or by means of a drive unit (PTU Power Drive Unit). In the ball mat region, which is placed in front of the bulk region of a hold, there are on one side guide elements opposite which, on the other side, there are guide elements which can be passed over. The guide elements which can be passed over can be offset in the Y direction in relation to the hold, that is to say transversely with respect to the longitudinal direction of the fuselage of an aircraft. Fastening the guide elements or locking bolts in the conveyor tracks in the floor region of the hold is carried out by means of bolts.

The disadvantages of this known embodiment can be seen in the fact that additional transverse roller tracks are necessary. Furthermore, an additional substructure under the transverse roller tracks is required in order to be able to transmit the forces which occur during impacts of items of freight or freight containers to the conveyor tracks in the X direction. Instead of standard ball mats normally used in the floor region of the hold, special ball mats additionally to be tailor-made are required in the region of the transverse roller tracks. A further considerable disadvantage of this solution is the interruption to the thermal insulation as a result of the installation of the transverse roller tracks, which can lead to the formation of condensation if there is excessively high cooling of the cabin air. From a logistical point of view, a considerable multiplicity of parts has to be kept in stock in the case of the known solution. Furthermore, the weight of the components used for positioning containers in the bulk region of a hold is afflicted with the disadvantage that the latter has a high weight.

On the basis of the outlined prior art, the invention is based on the object of implementing the alignment and the movement of bulky items of freight or freight containers of standardized size in restricted storage areas of holds.

According to the invention, this object is achieved by the features of patent claims 1 and 8.

The advantages of the solution according to the invention are primarily to be seen in the fact that the first and second guide elements can be mounted on conveyor tracks integrated into the floor surface of the hold, so that they can be positioned at those locations on the floor area of the hold at which alignment of items of freight or freight containers to be inserted into restricted storage areas can be carried out. For this purpose, a first guide element can advantageously be passed over as the weight of the item of freight or the freight container of standardized size to be stowed and, as a result, dips into the floor surface of the hold. Following the passage of the bulky item of freight or of the freight container of standardized dimensions, the spring pre-loaded guide section of the first guide element springs back into its extended position again and thus, in interaction with a further guide element that aligns the item of freight or the freight container and is provided with an erectable surface, can position the bulky freight container in such a way that the latter can be moved into its final storage position by the driving units which are provided above the conveyor tracks and can be driven in both directions of rotation. By performing the alignment of the freight container to be stowed at a location in the hold which is physically less restricted, its accurate alignment is possible.

In particular, with the method according to the invention, the utilization of tail regions of airplanes is possible, in that a freight container or items of freight in the leading door region of the hold corresponding to the envisaged further storage space or a plurality of envisaged storage spaces can be aligned in additional storage area regions of a hold, where sufficient space is available, and the positions of the aligning elements can be adapted in particular to the magnitude of the freight container sizes respectively to be loaded and inserted into the storage spaces. Therefore, in the additional storage area region of a hold, freight containers or items of freight can be accommodated lying behind one another or beside one another and locked in their storage spaces. Furthermore, with the method according to the invention for positioning freight containers and the subsequent insertion into defined storage spaces, it is possible that the, as a result of aligning a conveyor track with second erectable guide elements accommodated thereon with a demarcation surface of a storage space, only minimal modifications in the floor surface of a hold of an airplane are required.

In a development of the idea on which the invention is based, the forces introduced into the second guide elements by the items of freight or freight containers can be introduced into the conveyor tracks in the floor surface of the hold transversely with respect to the second direction, that is to say with respect to the X direction. This saves additional reinforcing constructions having to be provided in the shell of the fuselage of an airplane. The releasable locking of the first and second guide elements to the conveyor tracks or conveyor track sections running transversely with respect to the conveyor tracks makes it advantageously possible to adapt the alignment position in a first direction (Y direction) to the size or the dimensions of bulky items of freight or freight containers to be stowed in the hold. If, for example, a specific number of freight containers of standardized size are transported during a transport, different alignment positions for the freight containers may be required in the floor surface of the hold as compared with the transport of a relatively large number of freight containers which have smaller external dimensions.

The driving units in the floor surface, preferably configured as a PDU (=Power Drive Unit) are oriented in the floor surface so as to act in the X direction. The drive of the drive units, which grip and convey by friction the underside of the bulky items of freight or the freight containers to be aligned and to be stowed, can be provided both in the X direction, that is to say in the longitudinal direction of the hold; alternatively, drive of the drive rolls of the drive units in the direction of the hold opposite to the X direction is also possible. In addition, the driving units in the floor surface of the hold can also be accommodated on the conveyor tracks provided there so as to act in the Y direction, it being possible for both directions of rotation to be chosen freely on the drive units oriented in this way.

In a preferred development of the idea on which the invention is based, guide sections of the first guide element, if loaded by a bulky item of freight or a freight container, assume a position retracted into the floor surface of the hold and spring back up into their extended position only after the passage of the underside of the bulky item of freight or of the freight container. Therefore, immediate securing of the bulky item of freight/freight container to be aligned on a first guide element and then appropriately activated second guide element on the floor surface of the hold is possible without the bulky item of freight/freight container itself being left to its own devices.

According to the invention, the object is also achieved according to claim 8 by a device for positioning items of freight or freight containers on the floor surface of a hold, comprising conveyor tracks and drive units integrated into the floor surface, first guide elements which can be passed over being arranged in the floor surface and replaceable second guide elements being integrated into at least one of the conveyor tracks, and the conveyor tracks accommodating the second guide elements being arranged to align with one of the demarcations of an additional storage area region, on which locking elements are accommodated.

The advantage of the solution proposed according to the invention is to be seen in the fact that a changeover or the normal installation to utilize the bulk region of a hold in an aircraft can be performed significantly less expensively and more simply, since only a few additional components are required. Since the second guide elements are let into a roller track which is aligned with a lateral demarcation of the additional storage area region, the item of freight or freight container aligned with the second guide elements is automatically aligned and ready to be inserted into one of the storage spaces of the additional storage area region in the bulk region of the hold. Since, in order to utilize or change over the bulk region, only a few, largely standardized, components are required, the changeover operation or the initial installation proceeds quickly and without excessive effort. A further advantage is to be seen in the fact that the standard ball mats tailor-made as standard can be maintained, and no expensive and complex special tailoring of these parts is required in order to lay out the floor surface. Finally, a further advantage of the solution according to the invention is to be seen in the fact that, by virtue of the use of only a few components, a considerable advantage in terms of weight can be achieved as compared with the additional useful load which can be carried along as a result of utilizing the bulk region.

In a development of the solution on which the invention is based, guide bodies of the second guide elements are accommodated so as to be aligned with stop surfaces of locking elements of a demarcation on the additional storage area region, so that the insertion of the item of freight or freight container aligned with the second guide elements into a storage space in the additional storage area region can be made considerably easier and automated. The additional storage area region that can be utilized in the bulk region can comprise one or more storage spaces for items of freight or freight containers, so that a plurality of items of freight or a plurality of additional freight containers can be positioned there.

In a design variant of the solution according to the invention, the first guide elements, the second guide elements and the locking elements at a demarcation of the additional storage area region can be provided with sliding bodies which are effective in a first direction, a second direction or in the Z direction (vertical axis of the airplane). Accommodating additional abrading or sliding bodies on the guide or locking elements permits separation of the functionalities of corrosion prevention and sliding properties by the use of different materials. By means of the sliding bodies proposed according to the invention, rollers on the locking elements can additionally be avoided, said rollers causing additional weight and their installation space being restricted. Furthermore, with this solution, the corrosion protection of the component is not affected detrimentally, the simple re-manufacture of a used sliding body being ensured by its ability to be replaced on the guide or locking element. As compared with the solution disclosed by the prior art, the solution according to the invention offers the advantage that, when abrasion takes place at a point of contact, the complete component, that is to say the guide body of the guide element, does not have to be replaced completely and recoated in order to produce the corrosion protection again, instead that only the replaceable sliding or abrading body accommodated in the guide or locking element has to be replaced. Expensive machining operations can be saved in the solution according to the invention.

The sliding bodies preferably comprise an abrasion-resistant, nonmetallic material and are preferably replaceably accommodated in the guide and locking elements. Alternatively, the sliding body can also be held by the guide elements or the locking elements by a form fit. The sliding body can also be adhesively bonded into the guide elements or the locking elements. In addition, it is of course also possible to let the sliding body replaceably into the guide or locking elements by means of screwing, riveting or latching.

The first and second guide elements are advantageously provided with latching elements, with which the first and second guide elements can be locked at any desired locations in the conveyor tracks in the floor surface of the hold.

The first guide elements are preferably provided with a locking device fixing the guide in its retracted position, it being possible for the locking device to be operated manually or by foot or electromagnetically or electromechanically. In order to accommodate the secure fastening of the first and second guide elements in the floor surface of the hold, the conveyor tracks extended substantially in the X direction in the floor surface in the hold are provided with openings, which are at the same distance from one another, in which latching elements of the first and second guide elements engage and reliably fix the first and second guide elements in order to absorb the alignment or impact forces.

The second guide elements are preferably provided with an erectable guide body, which can be transferred by spring force from its folded-flat position into an erected position. An erectable guide body, on which a contact surface is formed, can be transferred into an erected position by means of a safety release pin, which can be actuated manually or electromagnetically or electromechanically.

The device proposed according to the invention for positioning bulky items of freight or freight containers can preferably be placed in the freight loading region of airplanes.

The invention will be explained in more detail below using the drawing, in which:

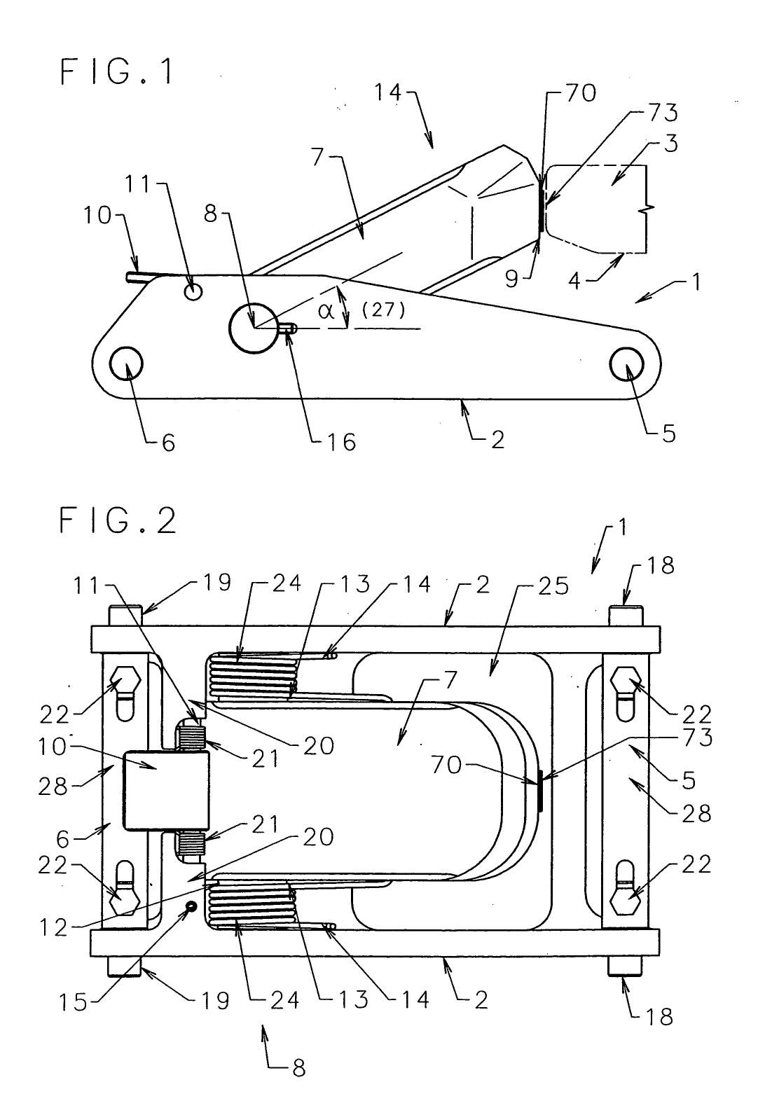

FIG. 1 shows a passable guide element in the extended position,

FIG. 2 shows the plan view of a passable guide element in the extended position,

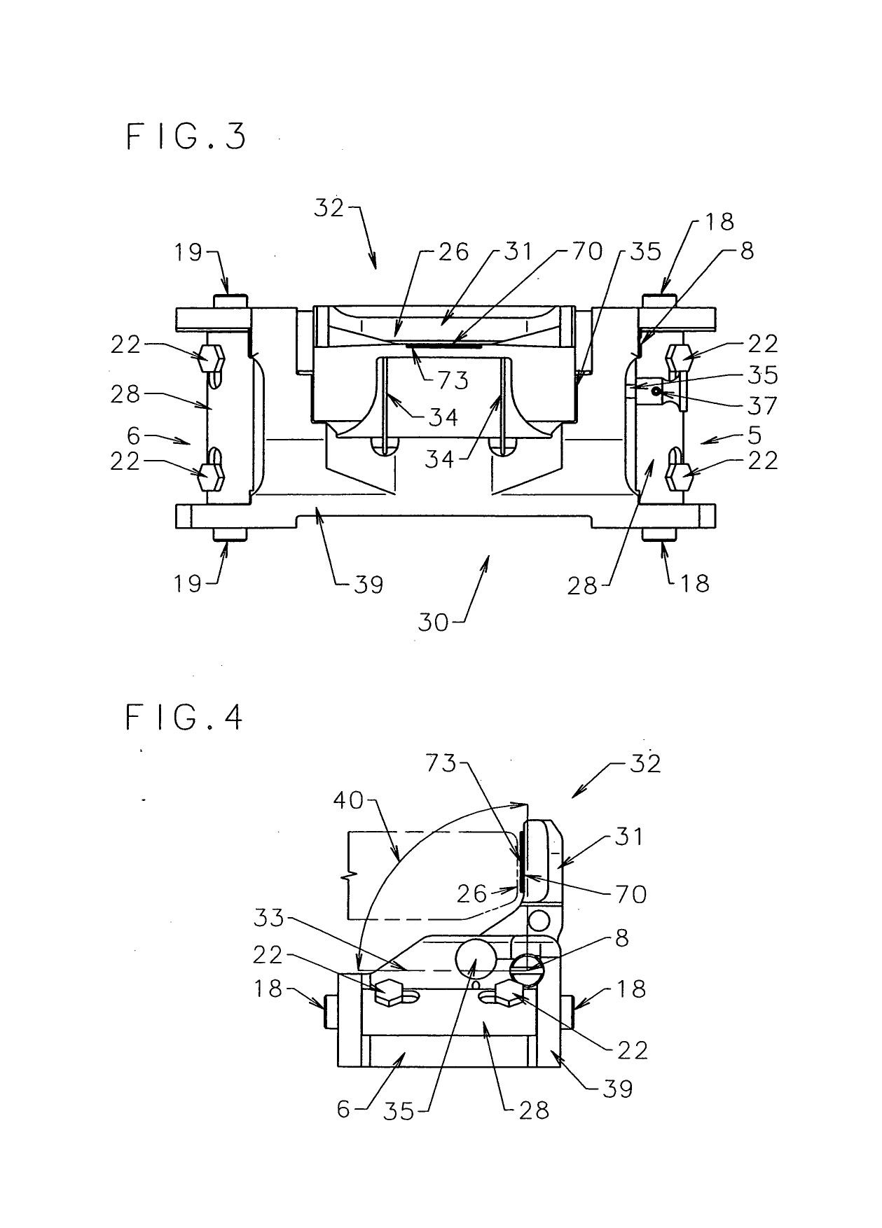

FIG. 3 shows the plan view of an erectable guide element,

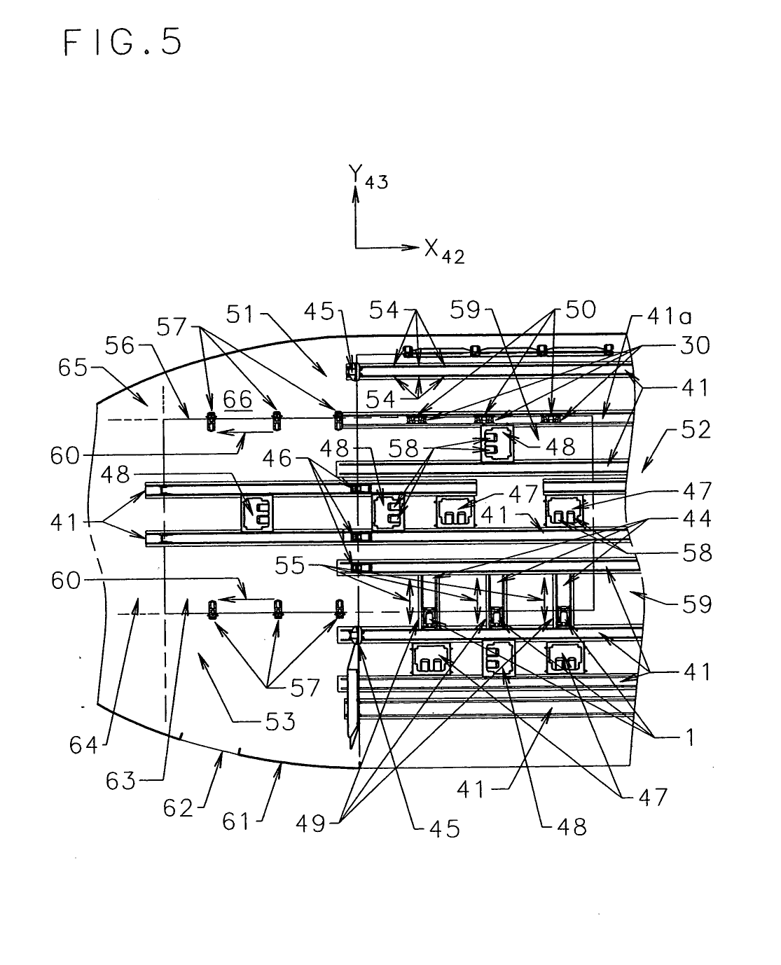

FIG. 4 shows the front view of an erectable guide element and

FIG. 5 shows the floor surface of a hold with integrated conveyor tracks, on which drive units and the first and second guide elements proposed according to the invention are accommodated,

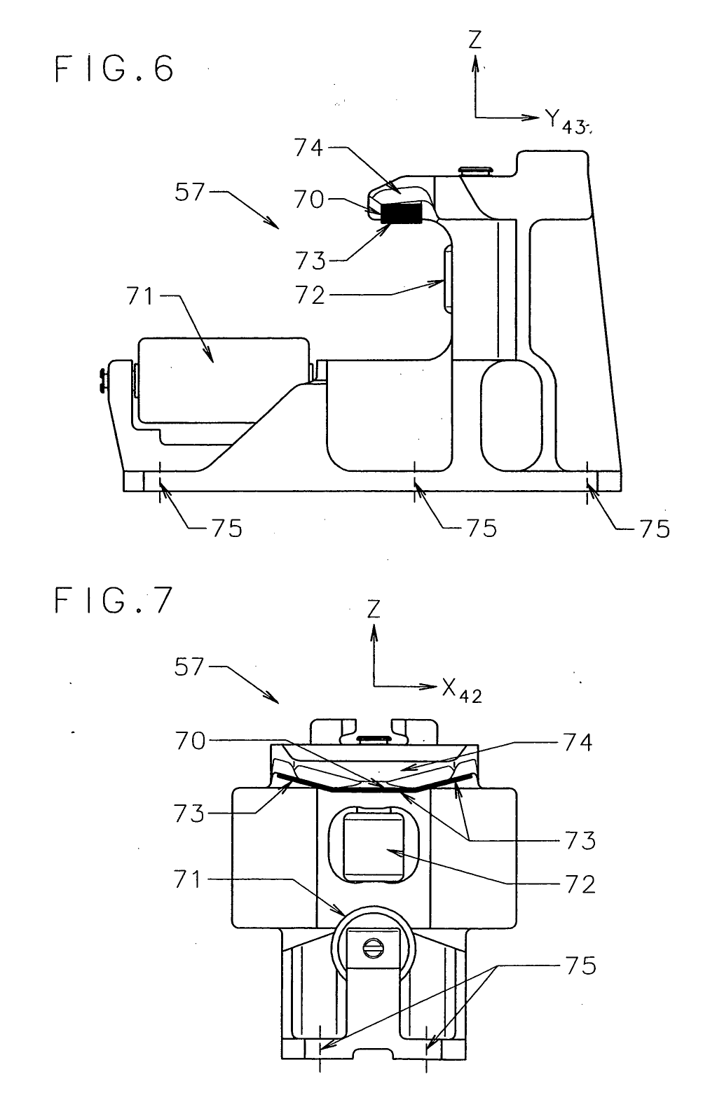

FIG. 6 shows a locking element, which is associated with a lateral demarcation of the additional storage area region and into whose Z-shaped nose a sliding body is let, and

FIG. 7 shows a locking element in the plan view with the sliding body of abrasion-resistant material let into the Z-shaped nose.

FIG. 1 shows a passable guide element in its extended position.

The illustration according to FIG. 1 reveals that a passable guide element 1 comprises an accommodating housing 2, in which a pivotable guide 7 is accommodated such that it can be pivoted about a pivot 8. In the accommodating housing 2 there run a first retaining bolt 5 and second retaining bolt 6, via which the accommodating housing 2 of the passable guide element 1 can be locked on conveyor tracks 44 in the floor surface 51 of a hold. In the state illustrated in FIG. 1, the pivotable guide 7 with guide surface 9 formed thereon has been placed in an extended position 17. In this position, a freight container 3, whose underside 4 lies above the floor surface 51 of the hold and the upper side of the accommodating housing 2, is retained in position. In its extended position 17, the pivotable guide 7 with guide surface 9 formed thereon and fixing the freight container 3 assumes a pivoting angle 27 designated by a in the illustration according to FIG. 1. The pivotable guide 7 can be pivoted about its pivot 8, which extends at right angles to the plane of the drawing through the accommodating housing 2. Designation 16 designates a clamping pin which prevents the pivot 8 rotating in the accommodating housing 2.

Also arranged in the accommodating housing 2 of the passable, first guide element 1 is a locking lever 10 which can be operated manually or by foot and which, in turn, can be moved about a lever axle 11. The locking lever 10 is also acted on by spring elements, not illustrated in FIG. 1.

FIG. 2 shows the plan view of a passable guide element in the extended position.

The illustration of the first, passable guide element 1 according to FIG. 2 reveals that a first retaining bolt 5 and second retaining bolt 6 are arranged in end regions of the accommodating housing 2. The retaining bolts 5 and 6 comprise sleeves 28. The sleeves 28 and the retaining bolts 5 and 6 are penetrated by locking screws 22, with which bolt ends 18 and 19 can be held in the first retaining bolt 5 and second retaining bolt 6. Locking the first guide element 1 in openings 54 (cf. FIG. 5) from conveyor tracks 41, 41a can be performed quickly by loosening the clamping screws, so that the positions of the second guide elements can be adapted without difficulty to varying freight container sizes.

The pivot 8, on which the pivotable guide 7 is accommodated, can be enclosed by a spacer sleeve 12 which, in turn, is enclosed by a spiral spring 13. By means of the spiral spring 13, the pivotable guide section 7 is acted on by a pre-stressing force. The bow-shaped spring legs 14 of the spiral spring 13 are fastened in the accommodating housing 2.

The locking lever 10, accommodated on a lever axle 11, is in turn acted on by a pre-stressing force by means of a spring element 21 and permits the locking—be it by foot or by hand—of the pivotable guide 7 in a position retracted below the floor surface 51 of the hold. The lever axle 11 is held and secured against rotation in a transverse spar 20 of the accommodating housing 2 by means of a clamping pin 15 which extends at right angles to the plane of the drawing according to FIG. 2. The spring force applied by the spiral spring 13 depends on the spring material selected and depends on the number of turns 24 with which the spiral spring 13 surrounds the spacer sleeve 12 of the pivot 8.

The accommodating housing 2 of the first guide element 1 is preferably composed of machined aluminum; the pivotable guide 7 can be fabricated from stainless steel, while the locking lever 10 can be fabricated from aluminum. For the purpose of protection against corrosion, the accommodating housing 2 is provided with a corrosion-resistant coating and then sealed. The steel components, for example the first and second retaining bolt 5 and 6 and the pivotable guide 7, are passivated, it being possible for the actuating elements of the first guide element 1, that is to say the locking lever 10, to be kept in a contrast color, for example red. The spacer sleeve 12 which surrounds the pivot 8 of the pivotable guide element 7 is preferably fabricated from bronze. The lever axle 11 of the locking lever 10 can also be enclosed by a sleeve, which can likewise be fabricated from bronze or another, softer metallic material. The torsion springs 21 can be accommodated on the outer circumferential surface of the sleeve surrounding the lever axle 11 but not illustrated in FIG. 2.

The illustration according to FIG. 3 reveals the plan view of a second, erectable guide element.

Accommodated in the accommodating housing 39 of the second, erectable guide element 30, in a manner analogous to the accommodating housing 2 of the first, passable guide element 1, are a first retaining bolt 5 and second retaining bolt 6. On the retaining bolt 5 and 6 there are bolt ends 18 and 19 projecting from the outer surfaces of the accommodating housing 39. The bolt ends 18 and 19 of the first retaining bolt 5 and of the second retaining bolt 6 can be fixed in their position by means of locking screws 22; in addition, the bolt ends 18 and 19 can be prestressed by spring elements respectively integrated in the retaining bolts 5 and 6, so that they can be locked without tools at any desired mounting positions between conveyor tracks 41 in the floor surface of a hold. The pivot 8, on which the erectable guide body 31 is accommodated, passes in the longitudinal direction through the accommodating housing 39 of the second, erectable guide element 30. In the illustration according to FIG. 5, it is possible to see the ends of a spiral spring 34 which surrounds the pivot 8 of the erectable guide body 31. The unlocking pin 35 enabling the erection of the guide body 31 can be provided with a handle, which is fixed to the shaft of the unlocking pin 35 by means of a clamping pin 37.

The illustration according to FIG. 4 reveals the front view of a second, erectable guide element.

The erection angle 40 assumed by the guide body 31 when it assumes its extended position 32 is preferably 90°. A freight container, not illustrated, or a bulky item of freight to be aligned can be aligned on a contact surface 26 of the erectable guide body 31 of the second, erectable guide element 30, exactly at right angles to the conveyor tracks 41 running in the floor surface 50 of the hold, and can be moved into its stowage position by driving the appropriate drive units.

Both the guide surface 9 of the first, passable transfer element 1 and the contact surface 26 of the guide body 31 of the second guide element 30 can be provided with a sliding or abrading body 70 inserted into the surface and fastened such that it can be replaced. The latter preferably comprises an abrasion-resistant material having a beneficial effect on sliding properties. The sliding bodies 70 which can be integrated into the guide surface 9 or the contact surface 26 can easily be replaced in the event of wear, without complete reworking and therefore renewal of the corrosion prevention on the guide surface 9 of the first guide element 1 and the contact surface 56 on the guide body 31 of the second guide element 30 being necessary.

The pivot about which the erectable guide body 31 moves into its erected position 32 is identified by designation 8. The erection of the guide body 31 into its erected position 32 takes place after the unlocking pin 35 has been operated. By means of the unlocking pin 35, the guide body 31 is held in its folded-flat position 33, that is to say below the floor surface 51 of the hold.

The illustration according to FIG. 5 reveals the floor surface of a hold with integrated conveyor tracks, drive units assigned to the latter for the freight containers or items of freight and also the first and second guide elements arranged in accordance with the invention.

The floor surface 51 of a hold of an airplane comprises conveyor tracks 41 accommodated so as to be spaced apart from one another, and individual conveyor track sections 44, pointing toward the region of the loading door in the illustration according to FIG. 7, which are oriented at right angles to the conveyor tracks 41 in the floor surface 51 of the hold. Individual ones of the conveyor tracks 41 extending parallel to the longitudinal direction 42 (X direction) of the hold are provided with end stops 45.

The floor surface 51 of the hold is subdivided into a storage area region 52 extending substantially in the second direction 42, and an additional storage area region 53, which points toward the tail region of an airplane. In the storage area region 52, freight containers 3 which extend over the entire width of the hold in the Y direction 43 can be accommodated standing one behind another in the X direction 42, that is to say in the second direction, and can be stopped and locked at their storage spaces in the storage area region 52. In the loading door region of the storage area region 52, drive elements 47 and 48 are let in between the mutually spaced conveyor tracks 41. Each of these drive elements, which preferably comprise an electric drive, contains one or more driven rollers with disk-like drive elements 58. The drive elements, designated by designation 47, comprise driven rollers 48, with which freight containers 3 can be conveyed into the hold in the Y direction by friction on the underside 4; the drive elements designated by item number 48 comprise driven rollers or disk-like bodies 58, with which the freight containers or items of freight, gripped by friction on the underside 4, can be moved in the X direction 42 in the hold. Between the storage region 52 of the floor surface 51 and the additional storage area region 53 (bulk), there are accommodated a number of locking elements 46 which can be folded down and can be adjusted from a folded-down position, that is to say a position dipping into the floor surface 51, into a position extended from the latter. In the loading door region of the storage area region 52 of the floor surface 51 of the hold, a number of conveyor track sections 44 oriented in the transverse direction are let in between the conveyor tracks 41. In each case first passable guide elements 1 are arranged at mounting positions 49 in the conveyor track sections 44 extending in the Y direction 43 (first direction). Depending on the opening pattern which is formed on the webs of the conveyor track sections 44, the passable, first guide element 1 can be locked within a positioning region 55 on the conveyor track sections 44, in positions corresponding to these hole patterns formed. As a result, adaptation to different bottom surfaces of freight containers 3 to be aligned and inserted into storage spaces can be achieved.

The second, erectable guide elements 30 are accommodated at mounting positions 50 in one of the conveyor tracks 41 passing through the hold and extending in the X direction 42 (second direction). The second erectable guide elements 30, which, in the folded-up state, function as stop elements for the freight containers 3 to be positioned in the Y direction 43 in the hold and aligned in the X direction 42, are distinguished by the fact that the force introduction direction resulting from the freight containers 3 striking the erected surfaces of the second guide elements 30, and the mounting direction of the conveyor tracks 41a accommodating the second erectable guide elements 30 in itself are at right angles to each other in the hold. That one of the conveyor tracks 41a which contains the second erectable guide elements 30 accommodated in mounting positions 50 is preferably aligned with a demarcation 56 of an additional storage area 53, which adjoins the aforementioned storage region 52 of the floor surface 51 of the hold of an airplane, in such a way that the contact surface 26 of the guide body 31 forms the continuation of the demarcation 56. In order to position the second guide elements 30, let into the conveyor tracks 41 at the mounting positions 50, the lateral webs in each case bounding the conveyor tracks 41 are provided with an opening pattern 54 which is preferably configured as a hole pattern. The first passable guide elements 1 respectively to be mounted at the mounting positions 50 and 49 in relation to the conveyor track sections 44, or the second erectable guide elements 30, engage in the openings according to the hole pattern 54 in the lateral webs of the guide tracks 41, with locking bolts which can be extended by clamping screws.

The illustration according to FIG. 5 reveals that a first storage space 63 of an additional storage area 53 in the tail region of an airplane along the demarcation 56, which runs in alignment with a conveyor track 41, is assigned a number of locking elements 57. The locking elements 57 are also found again on the demarcation, located opposite the demarcation 56, of the first storage space 63 on the additional storage area 53 in the hold. The additional storage area 53 of the floor surface 51 of the hold in the tail region of an airplane can contain a plurality of storage spaces. In addition to the first storage space 63 illustrated in FIG. 7, further storage spaces 64, 65 and 66 can be provided, in which freight containers 3 aligned in accordance with the invention and positioned in the hold in relation to the respective storage spaces 63, 64, 65, 66 to facilitate smooth insertion can be inserted. As viewed in the insertion direction 60, the freight containers can be accommodated either standing one behind another or standing one beside another on the storage spaces 63, 64, 65, 66 of the additional storage area region 53 of the hold.

The region between the mutually spaced conveyor tracks 41 in the storage area region 52, which is designated by designation 59, is designed with appropriately tailor-made ball mat sections, so that the freight containers or items of freight 3 to be positioned in the hold distribute their weight uniformly on the floor surface 51 of the hold. In addition, the region between the conveyor tracks 41, between which the conveyor track sections 44 oriented in the transverse direction extend, is laid out by means of appropriately tailor-made ball mat regions, in order to ensure a uniform weight distribution of the freight containers 3 or items of freight to be positioned and conveyed into the storage spaces.

The course of the outer wall of an airplane in the tail region, which can optionally contain an additional loading opening 62, is indicated by item number 61.

If a freight container 3 is moved in the Y direction 43 (that is to say the first direction) on the floor surface 51 of the hold, then the pivotable guide surfaces 7 of the first passable guide elements 1 are pressed into their retracted position by the weight of the freight container 3. On account of the weight of the freight container 3 conveyed on the floor surface 51, they remain in their retracted position until the freight container 3 strikes one or more of the second erectable guide elements 30. As soon as the underside 4 of the freight container 3 has passed over the first passable guide elements 1, the pivotable guides 7 spring upward on account of the action of the spiral spring 13 and secure the freight container 3 in its aligned position. In this aligned position, the conveyor track 41, into which the erectable guide elements 30 are let in their mounting positions 50, are aligned with a demarcation 56 of a first storage space in the additional storage region 63 in the tail region of the airplane. Arranging the first, passable guide elements 1 in the first, passable guide elements 1 accommodated in defined mounting positions 49 in conveyor track sections 44 extending in the transverse direction ensures that the freight container is positioned exactly in the Y direction 43 in relation to the first storage space 63 of the additional storage region 53. By means of the drive elements 48 acting in the X direction 42, the aligned freight container 3 can be moved onto the first storage space 63 in the insertion direction 60. Laterally, the freight container 3 to be accommodated in the additional storage region 53 is locked in the Y direction and in the Z direction by locking elements 57, while the aforementioned locking levers 46 are moved manually or automatically into their erected position and secure the freight container 3 moved in on the first storage space 63 in the X direction 42 and in the Z direction. The procedure can be analogous if further freight containers 3 or items of freight are to be accommodated standing in rows standing one behind another or one beside another in the additional storage region 53 of the floor surface 51 of the hold of an airplane. If freight containers 3 are positioned on the first storage space 63 and the further storage spaces 64, 65 and 66 of the additional storage region 53, the conveyor tracks 41 have to be lengthened accordingly and further drive units 48 acting in the X direction 42 have to be provided.

Using the method proposed according to the invention ensures that, before insertion of freight containers 3 in the insertion direction 60 on storage spaces 63, 64, 65 and 66 provided in the additional storage region 53, the freight containers 3 are positioned correctly in the Y direction 43 and smooth insertion of the freight container 3 onto its appropriate storage space can be carried out. The ability of the first, passable guide elements 1 to be positioned variably on the conveyor track sections 44 extending in the transverse direction of the hold permits adaptation of the alignment positions to different freight container sizes.

FIG. 6 shows a locking element 57 which, for example, can be mounted at a lateral demarcation 56 of the additional storage area region 52, aligning with a roller track 41a.

The locking element 57 comprises, in its bottom region, openings 75 with which it can be fixed, by using bolts or screws, in the floor of the bulk region, that is to say the additional storage area region 53. The locking element 57 has further rolling bodies 71 oriented in the horizontal direction and vertically oriented rolling bodies 72 arranged at right angles to the former, which permit easy insertion of the additional items of freight of the freight containers 3 in the direction of the X direction running in the plane of the drawing (that is to say in the first direction 42). Formed beside these on the locking element 57 is a nose-like overlapping protrusion 74 (Z nose), with which the freight containers or items of freight are secured in the Z direction shown during the flight. On the underside of the Z nose 74, sliding bodies 70 are let in, whose contact surface 73 projects in an elevated manner beyond the demarcation of the Z nose. The sliding body 70 arranged here in the underside of the overlapping protrusion 74 (Z nose) is preferably composed of a nonmetallic, abrasion-resistant material and can, for example, be accommodated in the underside of the Z nose 74 such that it can be replaced. The sliding body 70 can firstly be adhesively bonded in on the underside of the overlapping protrusion 74 (Z nose); it can also be fixed by clamping. In addition to clamping and adhesively bonding the sliding body 70 into the overlapping protrusion 74 (Z nose) of the locking element 57, the sliding body 70 can also be screwed in the latter, riveted or latched to the overlapping protrusion 74 (Z nose).

The illustration according to FIG. 7 reveals the plan view of a locking element 57.

The plan view according to FIG. 7 reveals that the contact surface 73 of the sliding body 70, let into the overlapping protrusion 74 (nose) stands out in an elevated manner beyond its underside. The freight container 3, not illustrated here, or the item of freight or freight container 3 to be stowed runs on the horizontally oriented bodies 71 in the X direction (designation 42). The stop surface, effective in the Y direction (designation 43), is formed by a vertically oriented rolling body 72, while the locking of the item of freight against slipping or lifting off the floor surface, as viewed in the Z direction, is implemented by the protrusion 74 (Z nose) overlapping the bottom of the freight container or a pallet.

The integration of a sliding body 70 of abrasion-resistant, nonmetallic material reduces the weight on the locking element 57 as compared with the use of rollers. Furthermore, integration of the sliding body 70 into the nose-like protrusion 74 does not damage the corrosion protection of the locking element 57. Furthermore, the sliding body 70 can be replaced easily and substituted by a new one with unused sliding properties. The functional separation arising from displacing the sliding properties onto a sliding body 70 and displacing the guide properties to the roller-like elements 71 and 72 permits the respective components fulfilling the function to be replaced when they wear and avoids the substitution of a complete locking element 57 when it is only the material or functional properties of one of the elements listed which has been used up.

### List of Designations

1 First passable guide element 35 Unlocking pin
2 Accommodating housing 36 Clamping pin
3 Freight container 37 Pin
4 Underside of freight container 38 Pin
5 First retaining bolt 39 Accommodating housing
6 Second retaining bolt 40 Setting angle
7 Pivotable guide 41 Conveyor track
8 Pivot 42×direction (Guide direction)
9 Guide surface 43 Y direction
10 Locking lever (positioning direction)
44 Conveyor track directions
11 Lever axle in the transverse direction
12 Spacer sleeve 45 Conveyor track end stop
13 Spiral spring element 46 Locking lever
14 Spring leg 47 Y-direction drive element
15 Clamping pin (vertical) 48 x-direction drive element
16 Clamping pin (horizontal) 49 Mounting position of
17 Extended position passable guide element 1
18 Bolt end 50 Mounting position of erectable
19 Bolt end guide element 30
20 Transverse spar 51 Floor surface
21 Locking lever spiral spring protrusion 52 Storage area region
22 Locking screw 53 Additional storage area
23 Spiral spring abutment region
24 Turn 54 Conveyor track opening
25 Opening pattern
26 Contact surface 55 Positioning range FE 1
27 Pivoting angle α 56 Aligned demarcation of
28 Sleeve additional storage space
57 Y, Z locking element
30 Second, erectable guide element 58 Driven rollers
31 Guide body 59 Transfer area ball mats
32 Erected position 60 Insertion direction
33 Folded-flat position 61 Side of craft
34 Spiral spring 62 Loading opening
63 First storage space
64, 65, 66 Further storage spaces
70 Sliding body
71 Horizontal rolling body
72 Vertical rolling body
73 Contact surface
74 Overlapping protrusion
75 Fastening opening

1. A method of positioning items of freight or freight containers (3) on a floor surface (51) of a hold having conveyor tracks (41, 41a) integrated into the floor surface (51) and drive units (47, 48) let into the floor surface (51), one or more freight containers (3) passing over guide elements (1) accommodating first sliding bodies (70) and assigned to the conveyor tracks (41) in a first direction (43) or a second direction (42) and being aligned, on second guide elements (30) containing sliding bodies (70), in the first or second direction between the first guide elements (1) and the second guide elements (30), characterized in that the freight containers (3) are guided into one or more storage spaces (64, 63, 65, 66) of an additional storage area region (53) provided in the tail region of an airplane, in the second direction (42) or opposite thereto, the conveyor track (41a) which accommodates the second guide elements (30) within positioning regions (50, 55) and into which forces occurring in the Y direction (43) during the positioning of the freight containers (3) are introduced being aligned with respect to a demarcation (56) with locking elements (57) of the additional storage area region (53) such that a contact surface (26) of a guide body (31) forms the continuation of the demarcation (56).

2. A method as claimed in claim 1, characterized in that the forces introduced into the guide bodies (31) of the second guide elements (30) by the items of freight or the freight containers (3) during positioning are introduced into the conveyor track (41, 41a) transversely with respect to the longitudinal direction of the conveyor track (41a) or other conveyor tracks (41).

3. The method as claimed in claim 1, characterized in that the items of freight or freight containers (3) can be moved on a flat underside (4), in the first direction (43) and/or in the second direction (42), by drive units (47, 48) which are integrated into the floor surface (51) and can be switched in both directions of rotation.

4. The method as claimed in claim 3, characterized in that the drive units (47, 48) in the floor surface (51) are oriented so as to act in the first direction (43) or in the second direction (42).

5. The method as claimed in claim 1, characterized in that the first guide elements (1) assume a retracted position during the passage of an item of freight or a freight container (3) and, after the underside (4) of the item of freight or freight container (3) has passed, spring back into an extended position (17).

6. The method as claimed in claim 1, characterized in that, following alignment in the first direction (43), the freight containers (3) are I introduced one behind another into storage spaces (64, 63; 65, 66) or into storage spaces (64, 65; 63, 66) of the additional storage region (53).

7. A device for positioning items of freight or freight containers (3) in a first direction (43) on a floor surface (51) of a hold having conveyor tracks (41, 41a) and drive units (47, 48) integrated into the floor surface (51), having passable first guide elements (1) arranged in the floor surface (51), and second, replaceable guide elements (30) integrated into at least one of the conveyor tracks (41, 41a), characterized in that the conveyor track (41, 41a) which accommodates the second guide elements (30) and into which forces can be introduced in the Y direction (43) is aligned with one of the demarcations (56) of an additional storage area region (53) provided in the tail region of an airplane with locking elements (57), in such a way that a contact surface (26) of the guide body (31) forms the continuation of the demarcation (56).

8. The device as claimed in claim 7, characterized in that guide bodies (31) of the second guide elements (30) are aligned with stop surfaces (72) of the locking elements (57) of the demarcation (56) of an additional storage area region (53) of the floor surface (51).

9. The device as claimed in claim 7, characterized in that the additional storage area region (53) comprises one or more storage spaces (63; 64, 65, 66) to accommodate items of freight or freight containers (3).

10. The device as claimed in claim 7, characterized in that the first guide elements (1), the second guide elements (30) and the locking elements (57) are provided with sliding bodies (70) which are effective in a first direction (43) and/or a second direction (42) and/or in the Z direction.

11. The device as claimed in claim 10, characterized in that the sliding bodies (70) comprise an abrasion-resistant, nonmetallic material.

12. The device as claimed in claim 10, characterized in that the sliding body (70) in the guide elements (1, 30) or the locking elements (57) is held such that it can be replaced.

13. The device as claimed in claim 10, characterized in that the sliding body (70) is held by the guide elements (1, 30) or the locking elements (57) by a form fit.

14. The device as claimed in claim 10, characterized in that the sliding body (70) is adhesively bonded into the guide elements (1, 30) or the locking elements (57).

15. The device as claimed in claim 10, characterized in that the sliding body (70) is held in the guide elements (1, 30) or the locking elements (57) by clamping said elements.

16. The device as claimed in claim 10, characterized in that the sliding body (70) is held on the guide elements (1, 30) or the locking elements (57) by screwing, riveting or latching.

17. The device as claimed in claim 7, characterized in that the first guide elements (1) are provided with a locking device (10, 11) that fixes the pivotable guide (7, 9) in a position dipping into the floor surface (51).

18. The device as claimed in claim 17, characterized in that the locking device (10, 11) has to be released manually, electromechanically or by foot.

19. The device as claimed in claim 7, characterized in that the conveyor tracks (41, 41a) and conveyor track sections (44) are provided with openings (54), in which fastening elements of the first and second guide elements (1, 30) engage.

20. The device as claimed in claim 7, characterized in that the second guide elements (30) having the erectable guide body (31) can be transferred from their laid-flat position (33) into an erected position (32) manually, by foot or electromechanically.

21. The device as claimed in claim 7, characterized in that the second guide elements (30) comprise an unlocking pin (35), after whose operation the guide body (31) springs back into its erected position (32).

22. The device as claimed in claim 7, characterized in that accommodating housings (2, 39) of the first and/or the second guide elements (1, 30) comprise retaining bolts (5,6), whose bolt ends (18, 19) are acted on by integrated pre-stressing elements in order to lock them in the conveyor tracks (41, 41a, 44).

23. The use of the device as claimed in claim 7 in the hold of an airplane.
